(19) United States
(12) Patent Application Publication
(10) Pub. No.: US 2010/0133458 A1
(43) Pub. Date: Jun. 3, 2010

(54) SEPARATED-CONTROL VALVE DEVICE

(76) Inventor: Tien-Ho Chung, Changhua Hsien (TW)

Correspondence Address: Chien-Hui Su, P. O. Box 70-121 Taichung, Taichung City, 40899, TW

(21) Appl. No.: 12/325,267

(22) Filed: Dec. 1, 2008

(51) Int. Cl. F16K 31/52

(52) U.S. Cl. 251/280

(57) ABSTRACT

A separated-control valve device includes a sleeve having two inlet holes and an outlet hole defined therein. A limiter is received in the sleeve and has two grooves defined therein. A control assembly received in the limiter. The control assembly has a valve seat, two valves mounted in the valve seat, two driven members relatively connected to the two valves, two operating levers relatively connected to the two driven members.

### BACKGROUND OF THE INVENTION

1. Field of the Invention

The present invention relates to a valve device, and more particularly to a separated-control valve device.

2. Description of Related Art

A conventional valve device includes a housing having two inlets and an outlet formed in a bottom panel, a seat secured in the housing and having two ports and an aperture aligned with the inlets and the outlet of the housing. A rotary member is rotatably received in the housing, and engaged onto the seat, and includes a bore communicating with the aperture of the seat, and two slots selectively communicating with the ports of the seat when the rotary member is rotated relative to the housing and the seat. The seat and the rotary member are made of porcelain materials to make a water tight seal without spring members.

However, the rotary member of the conventional valve device is rotatable relative to the housing and the seat to selectively enclose/disclose the ports for guiding hot water and cold water flowing from the ports to the bore of the rotatory member. Therefore, the hot water and the cold water are relatively linked together due to the rotatory member is rotatable relative to the housing and the seat. It is hard to precisely adjust a water temperature and a water flow. Furthermore, the flows of the hot water and the cold water are linked and relatively provided. It can not separately adjust the flows of the hot water and the cold water. Thus, it is inconvenient to use the conventional valve device.

The present invention has arisen to mitigate and/or obviate the disadvantages of the conventional valve device.

### SUMMARY OF THE INVENTION

The main objective of the present invention is to provide an improved separated-control valve device for separately adjusting a temperature and a flow of water.

To achieve the objective, the separated-control valve device in accordance with the present invention comprises a sleeve having a space defined therein. A limiter is received in the sleeve. The limiter has a space defined in the limiter. Two grooves are respectively defined in a bottom of the space in the limiter. A control assembly is received in the sleeve and comprises a valve seat having two inlets respectively defined in a first end thereof. The two inlets longitudinally pass through the valve seat. The valve seat has a retaining space defined in an outer periphery of the two inlets in the first end of the valve seat for communicating with the two inlets. Two valves pass through the two inlets. Each valve has a head disposed on a first end thereof, and a pivotal portion disposed on a second end thereof. Two operating levers are pivotally mounted on the second end of the valve seat. Each operating lever has a first end relatively connected to the valve, a second end restrictedly received in a corresponding groove in the limiter, and a middle section pivotally connected to the second end of the valve seat. Two driven members are mounted on the second end of the valve seat. Each driven member has three corners respectively pivotally connected to the pivotal portion of a corresponding valve, the second end of the valve seat, and the first end of a corresponding operating lever.

The two operating levers are respectively pushed to relatively drive the corresponding driven member to relatively drive the corresponding valve for adjustably communicating the corresponding inlet with the retaining space via the adjacent aperture such that the flows of hot water and cold water are separately adjustable for precisely adjusting a temperature/flow of water.

Furthermore, a second embodiment of the separated-control valve device in accordance with the present invention shows a valve seat having two aprons longitudinally formed thereon to respectively define two inlets. The two inlets pass through the valve seat. The valve seat has a retaining space defined in an outer periphery of the two aprons and simultaneously communicated with the two inlets. Each inlet in the valve seat has a shoulder formed on an inner periphery thereof to correspond to the head of the corresponding valve for adjustably blocking the inlet. Therefore, each operating lever gradually vertically pushed to relatively drive a corresponding driven member. The driven member is pivoted relative to the second end of the valve seat to relatively push down a corresponding valve relative to the valve seat. A corresponding inlet is enclosed by the head of the corresponding valve such that the retaining space is diminishingly communicated with the corresponding inlet. Each operating lever is gradually slantwise pushed to relatively drive a corresponding driven member. The driven member is pivoted relative to the second end of the valve seat to relatively pull up a corresponding valve relative to the valve seat for allowing a corresponding inlet increasingly communicating with the retaining space such that a temperature and a flow of water is separately adjustable.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a separated-control valve device in accordance with the present invention;

FIG. 2 is an exploded view of the separated-control valve device in another direction in accordance with the present invention;

FIG. 3 is an elevational view of a first end of a valve seat of the separated-control valve device in accordance with the present invention;

FIG. 4 is an elevational view of a second end of the valve seat of the separated-control valve device in accordance with the present invention;

FIGS. 5-7 are side plan views of the valve seat of the separated-control valve device in accordance with the present invention;

FIG. 8 is a cross-sectional side plan view of a sleeve of the separated-control valve device in accordance with the present invention;

FIG. 9 is a cross-sectional side plan view of a control assembly assembled in the limiter of the separated-control valve device in accordance with the present invention;

FIGS. 10-12 are operational perspective views of the separated-control valve device in accordance with the present invention;

FIG. 13 is a cross-sectional view of the separated-control valve device in accordance with the present invention taken along line A-A in FIG. 10;

FIG. 14 is a cross-sectional view of the separated-control valve device in accordance with the present invention taken along line B-B in FIG. 11;

FIG. 15 is an exploded view of a second embodiment of a separated-control valve device in accordance with the present invention;

FIG. 16 is a cross-sectional side plan of a sleeve of the second embodiment of the separated-control valve device in accordance with the present invention;

FIG. 17 is a cross-sectional side plan view of a control assembly assembled in the limiter of the second embodiment of the separated-control valve device in accordance with the present invention;

FIG. 18 is an operational cross-sectional view of the second embodiment of the separated-control valve device in accordance with the present invention;

FIG. 19 is an operational cross-sectional view of the second embodiment of the separated-control valve device in accordance with the present invention.

### DETAILED DESCRIPTION OF THE INVENTION

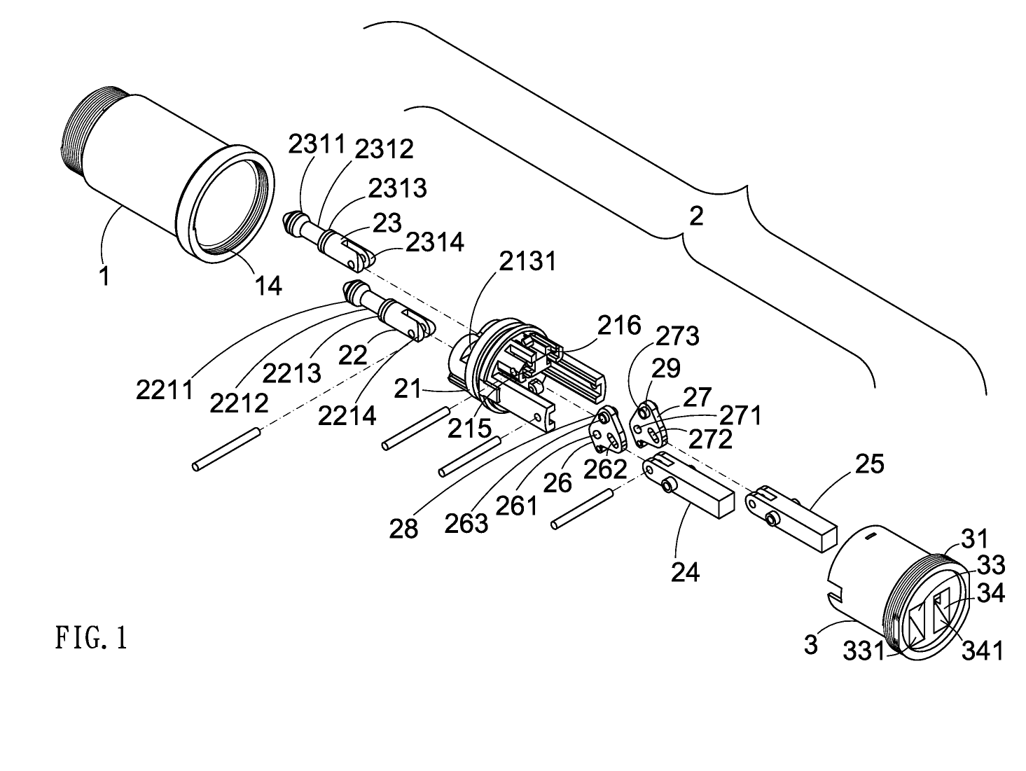

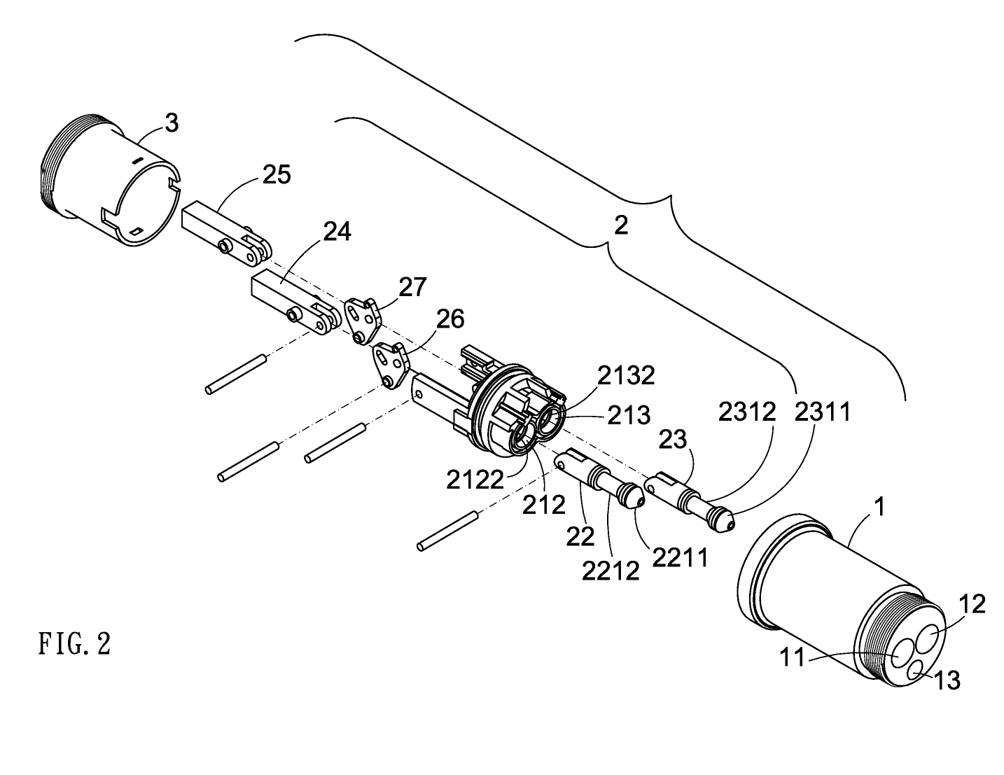

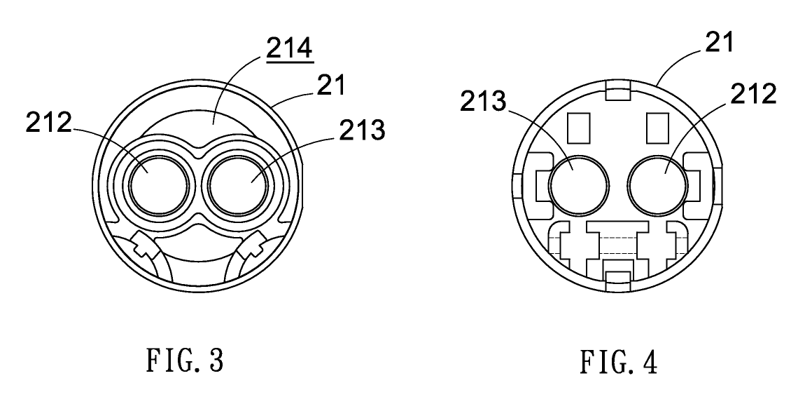

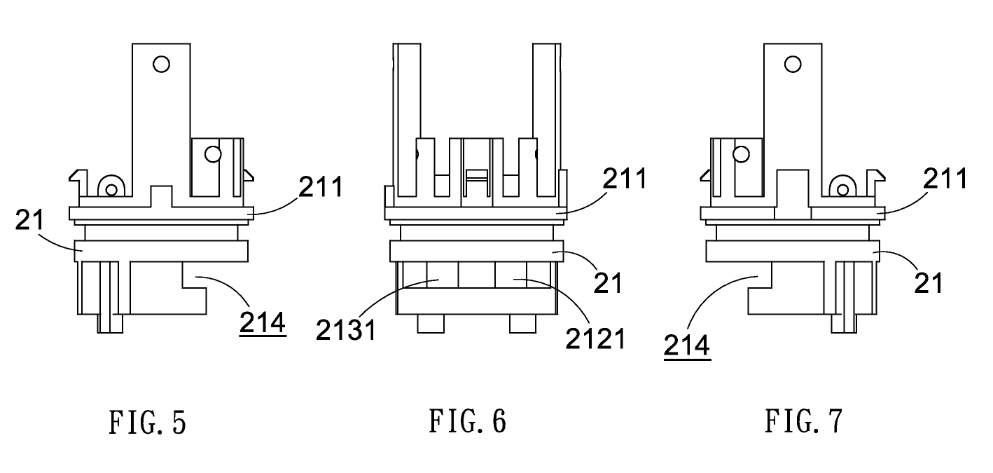

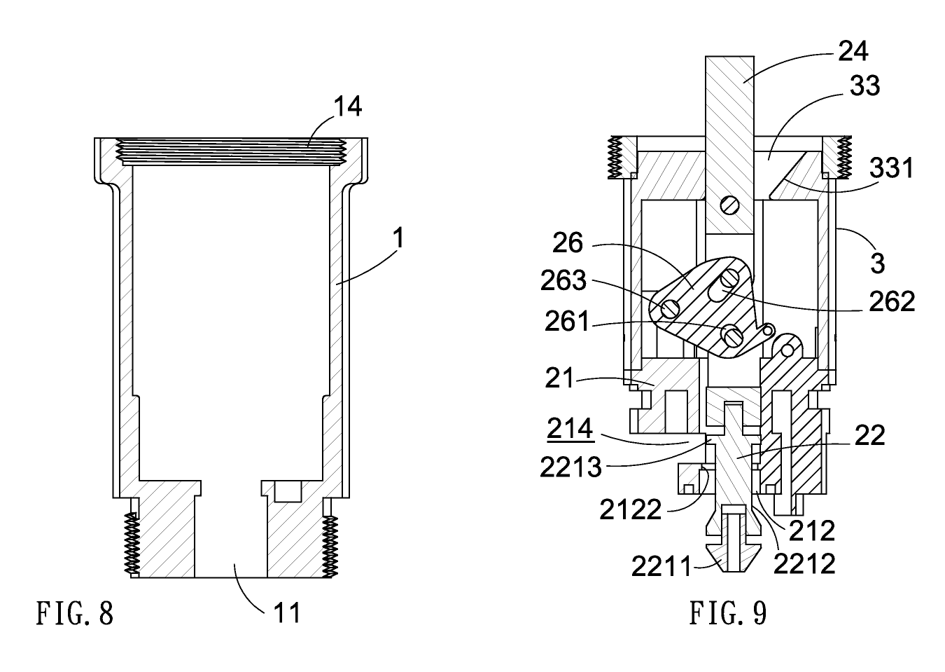

Referring to the drawings and initially to FIGS. 1-9, a separated-control valve device in accordance with the present invention comprises a sleeve (1), a control assembly (2) received in the sleeve (1), a limiter (3) unrotatably mounted on the control assembly (2) and received in the sleeve (1).

The sleeve (1) has a tubular structure. The sleeve (1) has a space defined therein and multiple threads (14) formed on an inner periphery formed thereof. The sleeve (1) has two inlet holes (11, 12) and an outlet hole (13) defined in a bottom of the space in the sleeve (1).

The control assembly (2) includes a valve seat (21), two valves (22, 23) mounted in the valve seat (21), two driven members (26, 27) relatively connected to the two valves (22, 23), two operating levers (24, 25) relatively connected to the two driven members (26, 27). The valve seat (21) has two inlets (212, 213) respectively defined in a first end of thereof and longitudinally passing through the valve seat (21). Each inlet (212, 213) has an inner flange (2122, 2132) formed on an inner periphery thereof. Each inlet (212, 213) longitudinally aligns a corresponding inlet hole (11, 12) of the sleeve (1) when assembling. A retaining space (214) is defined in an outer periphery of the two inlets (212, 213) in the first end of the valve seat (21). Each inlet (212, 213) has an aperture (2121, 2131) laterally defined in the inner periphery thereof and extending therethrough. Each inlet (212, 213) is communicated with the retaining space (214) via the adjacent aperture (2121, 2131) for guiding water from the inlet (212, 213) to the retaining space (214). The two valves (22, 23) symmetrically correspond to each other. Each valve (22, 23) has a head (2211, 2311) disposed on a first end thereof, a body portion (2212, 2312) formed thereon adjacent to the head (2211, 2311), a sealing flange (2213, 2313) annularly extending therefrom adjacent to the body portion (2212, 2312), and a pivotal portion (2214, 2314) disposed on the second end thereof opposite to the first end. The two driven members (26, 27) symmetrically correspond to each other. Each of the two driven members (26, 27) has a triangular structure. Each driven member (26, 27) respectively have a hole (263, 273), a short slot (261, 271), and a long slot (262, 272) laterally defined in three corners of the triangular structure for respectively pivotally connecting to a second end of the valve seat (21), the pivotal portion (2214, 2314) of the valve (22, 23), and the operating lever (24, 25). In the preferred embodiment of the present invention, each driven member (26, 27) has a flange (28, 29) respectively extending from two lateral sides of the hole (263, 273) for connecting to the second end of the valve seat (21). The second end of the valve seat (21) has a corresponding silt (215, 216) to restrictedly receive the two flanges (28, 29) of each driven member (26, 27) for mounting the driven member (26, 27) on the valve seat (21) such that each driven member (26, 27) is pivotally connected to the second end of the valve seat (21). The two operating levers (24, 25) symmetrically correspond to each other. Each operating lever (24, 25) has a first end pivotally connected to the long slot (262, 272) in the driven member (26, 27), a second end partially received in the limiter (3), and a middle section pivotally connected to the second end of the valve seat (21).

The limiter (3) has a tubular structure. A space is defined in the limiter (3). Two grooves (33, 34) are respectively defined in a bottom of the space in the limiter (3) for allowing the second ends of the two operating levers (24, 25) partially receiving therein and respectively extending therethrough. Each groove (33, 34) has a slant surface (331, 341) formed on an inner periphery thereof for guiding a pivotal angle of a corresponding operating lever (24, 25). The limiter (3) has multiple threads (31) formed on an outer periphery thereof to correspond to multiple threads (14) of the sleeve (1) for securely mounting in the sleeve (1).

When assembling, the pivotal portions (2214, 2314) of the two valves (22, 23) respectively pass through the inlets (212, 213) in the valve seat (21) via the first end of the valve seat (21) and pivotally connect to a corresponding short slots (261, 271) of the driven member (26, 27). The sealing flange (2213, 2313) of each of the two valves (22, 23) is provided for preventing water from flowing to the second end of the valve seat (21). The holes (263, 273) of the two driven members (26, 27) are respectively pivotally connected to the second end of the valve seat (21). The first end of each operating levers (24, 25) is respectively pivotally connected to a corresponding long slots (262, 272). The middle section of each operating lever (24, 25) is pivotally connected to the second end of the valve seat (21). The limiter (3) is unrotatably mounted on the valve seat (21). The second end of each operating levers (24, 25) is respectively extending through a corresponding groove (33, 34) in the limiter (3). The control assembly (2) and the limiter (3) are received in the sleeve (1). The limiter (3) is securely mounted in the sleeve (1) due to the multiple threads (31) of the limiter (3) corresponding to multiple threads (14) of the sleeve (1). Each inlet (212, 213) is communicated with a corresponding inlet hole (11, 12) of the sleeve (1) and the retaining space (214) is communicated with the outlet hole (13). Each inlet (212, 213) is respectively and adjustably communicated with the retaining space (214) via the adjacent aperture (2121, 2131).

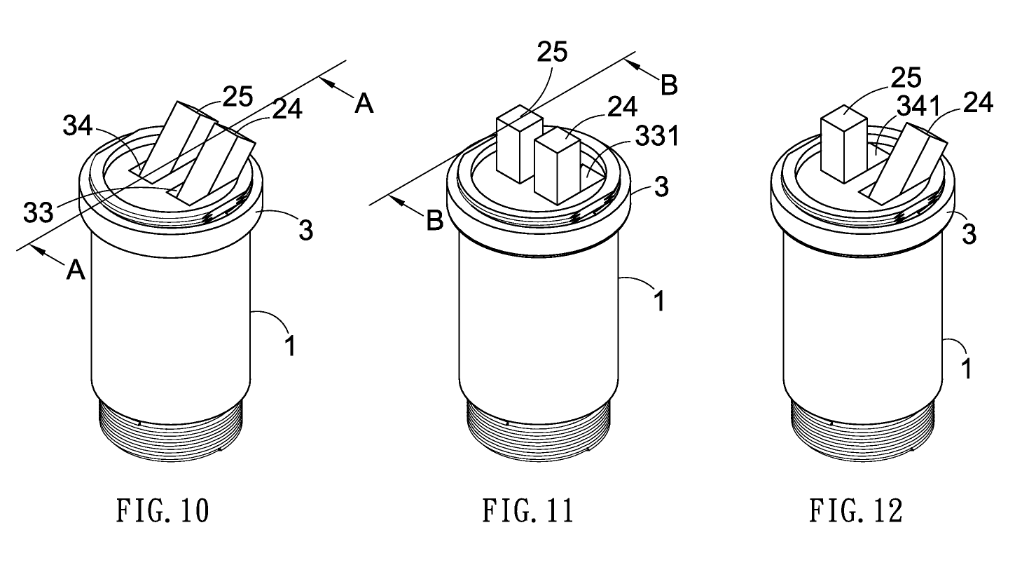

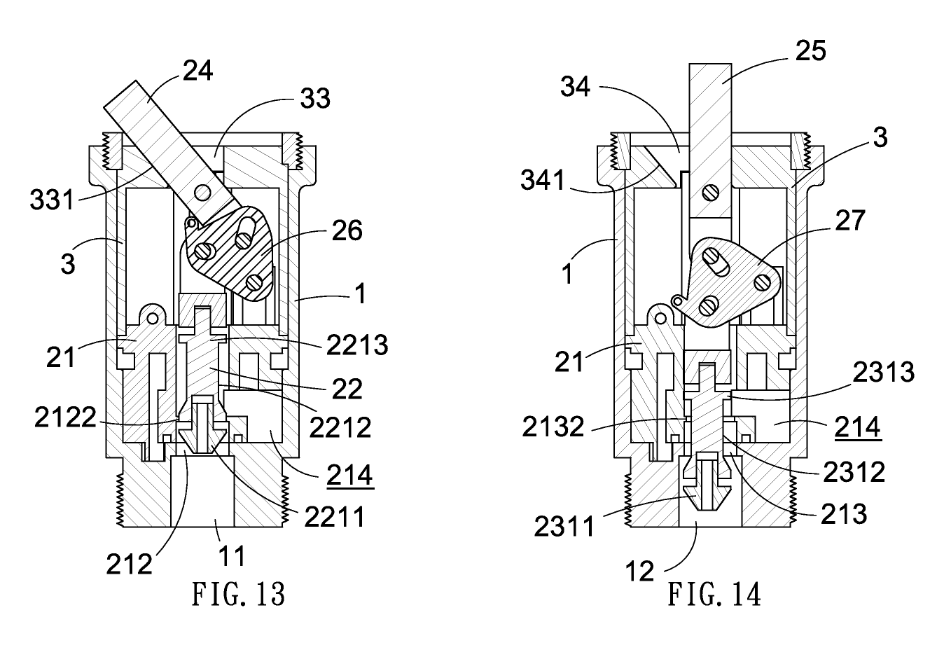

With reference to FIGS. 10-14, the two inlet holes (11, 12) in the sleeve (1) are respectively provided for connecting to a hot water tube (not shown) and a cold water tube (not shown), and the outlet hole (13) in the sleeve (1) is provided for connecting to a faucet (not shown). When less water is required, as shown in FIG. 10 and FIG. 13, the operating lever (24) is pushed toward the slant surface (331) of the groove (33) in the limiter (3). The operating lever (24) is gradually pivoted relative to the second end of the valve seat (21) and moved along the long slot (262) to drive the driven member (26) pivoted relative to the second end of the valve seat (21). The valve (22) is relatively driven by the driven member (26) and pulled up relative to the valve seat (21). The inlet (212) is gradually enclosed due to the head (2211) of the valve (22) blocked the inner flange (2122) of the inlet (212) in the valve seat (21) for gradually diminishing the water until the inlet (212) is enclosed and the water is stopped flowing. When more water is required, as shown in FIG. 11 and FIG. 14, the operating lever (25) is pushed away from the slant surface (341) of the groove (34) in the limiter (3). The operating lever (25) is gradually pivoted relative to the second end of the valve seat (21) and moved along the long slot (272) to drive the driven member (27) pivoted relative to the second end of the valve seat (21). The valve (23) is relatively driven by the driven member (27) and pushed down relative to the valve seat (21). The head (2311) of the valve (23) is gradually move away from the inner flange (2132) of the inlet (213) in the valve seat (21) such that the inlet (213) is unhinderedly communicated with the inlet hole (12) for guiding the water from the inlet (213) to the retaining space (214) and the outlet hole (13). Therefore, when the hot water tube and the cold water tube are respectively connected to the two inlet holes (11, 12) in the sleeve (1), the two operating levers (24, 25) are separately operated to relatively drive the two valves (22, 23) partially received in the valve seat (21) such that the flows of hot water and cold water are separately adjustable for precisely adjusting a temperature/flow of water.

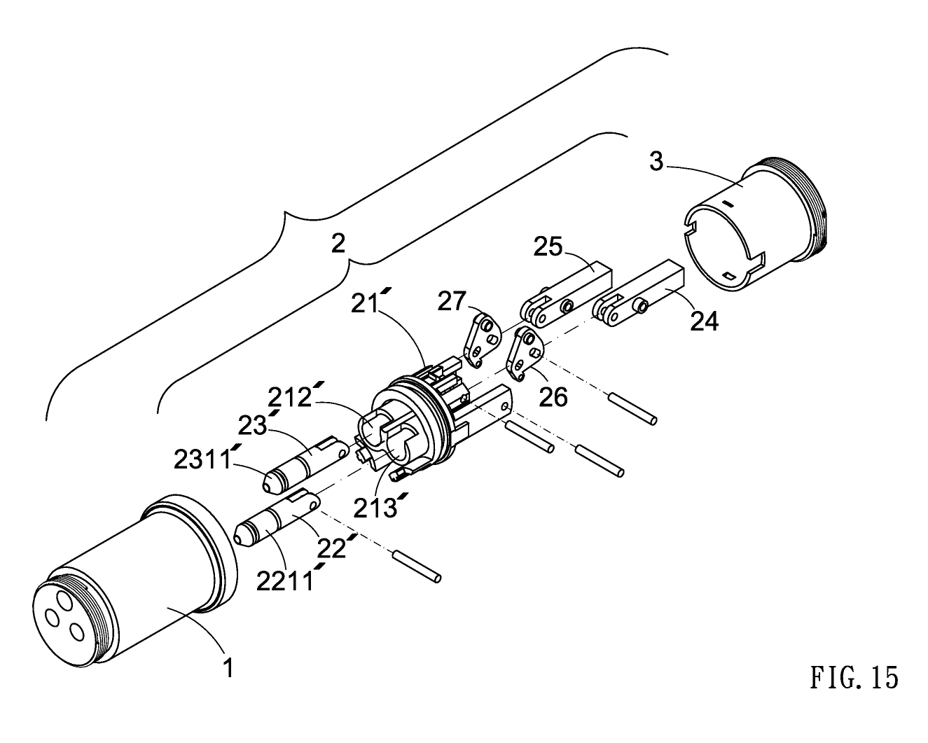

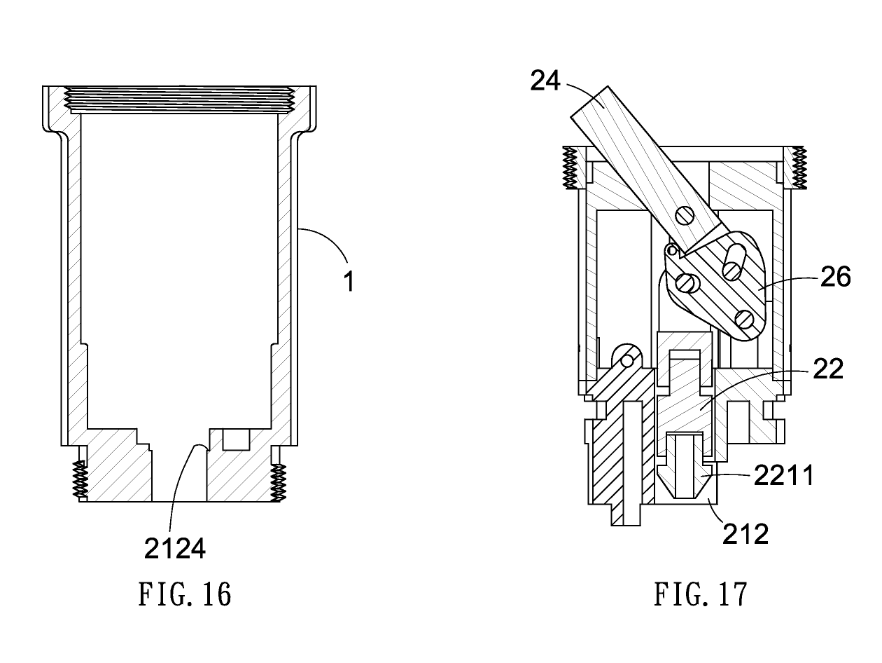

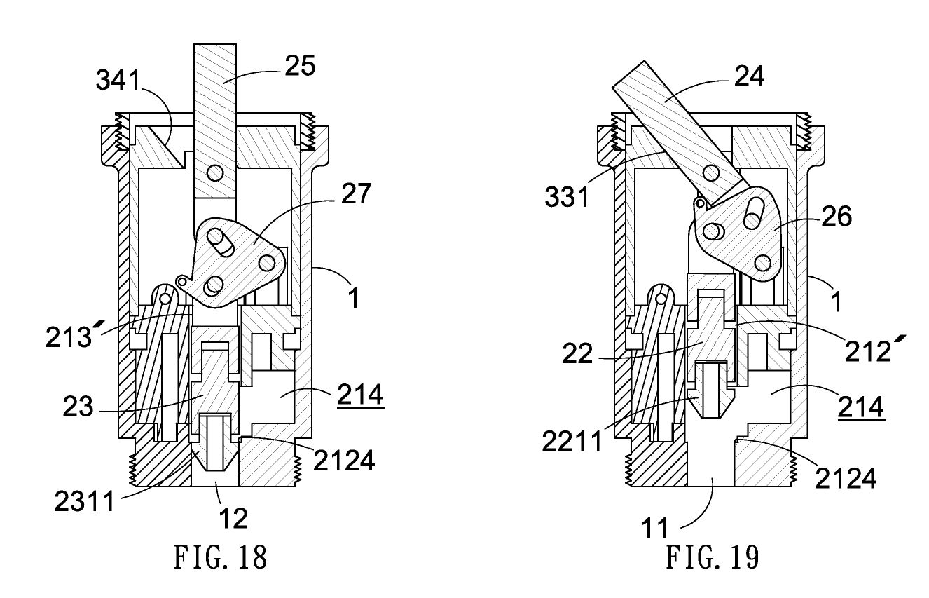

With reference to FIGS. 15-19, those show a second embodiment of the separated-control valve device in accordance with the present invention. The elements and effects of the second embodiment which are the same with the first embodiment are not described, only the differences are described. The valve seat (21′) has a first end having two aprons (not numbered) longitudinally formed thereon to respectively define two inlets (212′, 213′). The two inlets (212′, 213′) respectively longitudinally pass through the valve seat (21′). Each inlet (212′, 213′) has a shoulder (2124) formed on an inner periphery thereof. The two inlets (212′, 213′) of the valve seat (21′) are respectively aligned with the two inlet holes (11, 12) of the sleeve (1). A retaining space (214′) is defined in an outer periphery of the two aprons of the valve seat (21′) and simultaneously communicated with the two inlets (212′, 213′). Each valve (22′, 23′) respectively passes through a corresponding one inlet (212′, 213′) via the first end of the valve seat (21′) and connect to the corresponding one operating lever (24, 25). Each valve (22′, 23′) has a head (2211′, 2311′) disposed on a first end thereof, and a pivotal portion (2214, 2314) disposed on the second end thereof opposite to the first end for connecting to the corresponding operating lever (24, 25). When less water is required, as shown in FIG. 18, the operating lever (25) is vertically pushed away from the slant surface (331) of the groove (33) in the limiter (3). The driven member (27) is relatively driven by the operating lever (25) to push down the valve (23′) relative to the valve seat (21′). The inlet (213′) is gradually sealed due to the head (2311′) of the valve seat (21′) blocked the shoulder (2124) of the inlet (213′) for gradually diminishing the water until the inlet (213′) is enclosed and the water is stopped flowing. When more water is required, as shown in FIG. 19, the operating lever (24) is pushed toward the slant surface (341) of the groove (34) in the limiter (3). The driven member (26) is relatively driven by the operating lever (24). The valve (22′) is pulled up by the driven member (26) relative to the valve seat (21′). The head (2211′) of the valve (22′) is gradually moved away from the shoulder (2124) of the inlet (212′) in the valve seat (21′) such that the inlet (212′) is communicated with the inlet hole (11) for guiding the water from the inlet (212′) to the retaining space (214′) and the outlet hole (13). Therefore, the two valves (22′, 23′) are separately operated for separately adjusting hot water and cold water to precisely adjusting a temperature/flow of water.

Although the invention has been explained in relation to its preferred embodiment, it is to be understood that many other possible modifications and variations can be made without departing from the spirit and scope of the invention as hereinafter claimed.

What is claimed is:

1. A separated-control valve device comprising:
a sleeve having a space defined therein, the sleeve having two inlet holes and an outlet hole defined in a bottom of the space in the sleeve, the two inlet holes adapted for respectively connecting to a hot water tube and a cold water tube;
a limiter received in the sleeve, the limiter having a space defined in the limiter, two grooves respectively defined in a bottom of the space in the limiter;
a control assembly received in the sleeve and comprising:
a valve seat having two inlets respectively defined in a first end thereof, the two inlets longitudinally passing through the valve seat, the valve seat having a retaining space defined in an outer periphery of the two inlets in the first end of the valve seat for communicating with the two inlets;
two valves respectively passing through the two inlets, each valve having a head disposed on a first end thereof, and a pivotal portion disposed on a second end thereof;
two operating levers pivotally mounted on the second end of the valve seat, each operating lever having a first end relatively connected to the valve, a second end restrictedly received in a corresponding groove in the limiter, and a middle section pivotally connected to the second end of the valve seat; and
two driven members mounted on the second end of the valve seat, each driven member having three corners respectively pivotally connected to the pivotal portion of a corresponding valve, the second end of the valve seat, and the first end of a corresponding operating lever; and
wherein when each operating lever is gradually slantwise pushed to relatively drive a corresponding driven member, the driven member pivoted relative to the second end of the valve seat to relatively pull up a corresponding valve relative to the valve seat, a corresponding inlet enclosed by the head of the corresponding valve such that the retaining space is diminishingly communicated with the corresponding inlet;
when each operating lever gradually vertically pushed to relatively drive a corresponding driven member, the driven member pivoted relative to the second end of the valve seat to relatively push down a corresponding valve relative to the valve seat for allowing a corresponding inlet increasingly communicating with the retaining space such that a temperature and a flow of water is separately adjustable.

2. The separated-control valve device as claimed in claim 1, wherein each inlet in the valve seat has an inner flange formed on an inner periphery thereof to correspond to the head of the corresponding valve for adjustably blocking the inlet.

3. The separated-control valve device as claimed in claim 1, wherein each groove in the limiter has a slant surface formed on an inner periphery thereof for guiding a pivotal angle of the operating lever.

4. The separated-control valve device as claimed in claim 1, wherein each driven member has a triangular structure, three corners of the triangular structure respectively having a hole, a short slot, and a long slot laterally defined therein for respectively pivotally connecting to a second end of the valve seat, the pivotal portion of the valve, and the first end of the operating lever.

5. The separated-control valve device as claimed in claim 1, wherein each inlet in the valve seat has an aperture laterally defined in the inner periphery thereof and extending therethrough such that each inlet in the valve seat is communicated with the retaining space via the adjacent aperture for guiding water from the inlet to the retaining space.

6. The separated-control valve device as claimed in claim 1, wherein each valve has a sealing flange annularly extending from a middle section thereof for preventing water from flowing to the second end of the valve seat.

7. The separated-control valve device as claimed in claim 4, wherein each driven member has a flange respectively extending from two lateral sides of the hole for connecting to the second end of the valve seat, the second end of the valve seat having a corresponding silt to restrictedly receive the flanges of each driven member for mounting the driven member on the valve seat such that the driven member is pivotally connected to the second end of the valve seat.

8. A separated-control valve device comprising:
a sleeve having a space defined therein, the sleeve having two inlet holes and an outlet hole defined in a bottom of the space in the sleeve, the two inlet holes adapted for respectively connecting to a hot water tube and a cold water tube;
a limiter received in the sleeve, the limiter having a space defined in the limiter, two grooves respectively defined in a bottom of the space in the limiter;
a control assembly received in the limiter and comprising:
a valve seat having two aprons longitudinally formed thereon to respectively define two inlets, the two inlets passing through the valve seat, the valve seat having a retaining space defined in an outer periphery of the two aprons and simultaneously communicated with the two inlets;
two valves respectively passing through the two inlets, each valve having a head disposed on a first end thereof, and a pivotal portion disposed on a second end thereof;
two operating levers pivotally mounted on the second end of the valve seat, each operating lever having a first end relatively connected to the valve, a second end restrictedly received in a corresponding groove in the limiter, and a middle section pivotally connected to the second end of the valve seat; and
two driven members mounted on the second end of the valve seat, each driven member having three corners respectively pivotally connected to the pivotal portion of a corresponding valve, the second end of the valve seat, and the first end of a corresponding operating lever; and
wherein when each operating lever gradually vertically pushed to relatively drive a corresponding driven member, the driven member pivoted relative to the second end of the valve seat to relatively push down a corresponding valve relative to the valve seat, a corresponding inlet enclosed by the head of the corresponding valve such that the retaining space is diminishingly communicated with the corresponding inlet;
when each operating lever gradually slantwise pushed to relatively drive a corresponding driven member, the driven member pivoted relative to the second end of the valve seat to relatively pull up a corresponding valve relative to the valve seat for allowing a corresponding inlet increasingly communicating with the retaining space such that a temperature and a flow of water is separately adjustable.

9. The separated-control valve device as claimed in claim 1, wherein each inlet in the valve seat has a shoulder formed on an inner periphery thereof to correspond to the head of the corresponding valve for adjustably blocking the inlet.

10. The separated-control valve device as claimed in claim 1, wherein each groove in the limiter has a slant surface formed on an inner periphery thereof for guiding a pivotal angle of the operating lever.

11. The separated-control valve device as claimed in claim 1, wherein each driven member has a triangular structure, three corners of the triangular structure respectively having a hole, a short slot, and a long slot laterally defined therein for respectively pivotally connecting to a second end of the valve seat, the pivotal portion of the valve, and the first end of the operating lever.

12. The separated-control valve device as claimed in claim 11, wherein each driven member has a flange respectively extending from two lateral sides of the hole for connecting to the second end of the valve seat, the second end of the valve seat having a corresponding silt to restrictedly receive the flanges of each driven member for mounting the driven member on the valve seat such that the driven member is pivotally connected to the second end of the valve seat.
